(19) United States
(12) Patent Application Publication
(10) Pub. No.: US 2008/0157442 A1
(43) Pub. Date: Jul. 3, 2008

(54) Process For Cutting Textile Webs With Improved Microwave Absorbing Compositions

(75) Inventors: Robert Allen Janssen, Alpharetta, GA (US); Michael Joseph Garvey, Appleton, WI (US); Dennis John DeGroot, Appleton, WI (US); Earl C. McCraw, Duluth, GA (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: KIMBERLY-CLARK WORLDWIDE, INC., Neenah, WI (US)

(21) Appl. No.: 11/777,124

(22) Filed: Jul. 12, 2007

Related U.S. Application Data
(63) Continuation-in-part of application No. 11/617,405, filed on Dec. 28, 2006.

(51) Int. Cl. B29C 67/00

(52) U.S. Cl. 264/489

(57) ABSTRACT

The present disclosure provides for methods of using compositions having improved microwave absorbing properties to cut textile webs. Specifically, the compositions utilized in the methods of the present disclosure absorb the microwave energy as heat, thereby cutting through the textile web.

### CROSS REFERENCE TO RELATED APPLICATION

This patent application is a continuation-in-part patent application of U.S. patent application Ser. No. 11/617,405 filed on Dec. 28, 2006.

### FIELD OF DISCLOSURE

This disclosure relates generally to processes for cutting textile webs using compositions having improved microwave absorbing properties, and more particularly to a process for cutting textile webs in which microwave energy is used to facilitate the cutting process.

### BACKGROUND OF PRESENT DISCLOSURE

Sheets of polymeric materials, including films, e.g., polyethylene films, and nonwoven fabrics, e.g., spunbonded and meltblown polypropylene nonwoven webs, which materials typically are thermoplastic, have been used to make a variety of commercial products, such as diapers, feminine care products, gloves, and the like. Assembly of these products generally involves the steps of (1) cutting specified shapes from the sheets; (2) bonding two or more sheets together along specified contours; and (3) in some cases, printing a pattern on portions of the sheets which form the outer surface of the finished product. The bonding, cutting, and printing steps can, in general, be performed in any order, e.g., pre-cut and pre-printed sheets can be bonded together or full sheets (textile webs) can be bonded together, printed, and then cut.

Various techniques have been used to perform the cutting operation. For example, cutting dies having prescribed contours corresponding to those of the finished article have been used to cut polymeric sheets. A fundamental problem with the existing techniques is the extensive, and thus expensive, set-up steps which are required for each product which is to be manufactured. Thus, cutting dies, patterns, and the like have to be specifically fabricated on a product-by-product basis. In most cases, the cost of this tooling can only be supported by relatively large production runs. Also, in terms of manufacturing logistics, if a single production product must be stored between uses and the line must be shut down for an extended period of time each time the product being manufactured is to be changed. As with the tooling itself, these manufacturing problems add to the final cost of the product.

Based on the foregoing, there is a need for a cutting process that does not require the use of expensive cutting dies and other specialized equipment and facilitates improved cutting of a textile web using the same tooling for various products.

### SUMMARY OF THE PRESENT DISCLOSURE

Generally, the present disclosure provides for methods of using compositions having improved microwave absorbing properties to cut textile webs. Specifically, the compositions utilized in the methods of the present disclosure absorb the microwave energy, thereby heating the substrate materials sufficiently to melt and cut through the textile web.

As such, the present disclosure is directed to a process for cutting a textile web. The process comprises applying a composition having a dielectric loss factor at 900 MHz and 22 degrees Celsius of at least about 5 in a pattern to a first face of the textile web; moving the textile web through a microwave application chamber of a microwave system; and operating the microwave system to impart microwave energy to the textile web in the microwave application chamber to facilitate cutting of the textile web.

Other features of the present disclosure will be in part apparent and in part pointed out hereinafter.

### BRIEF DESCRIPTION OF THE DRAWINGS

FIG. 1 is a schematic of one embodiment of apparatus for cutting textile webs according to one embodiment of a process for cutting textile webs;

FIG. 2 is a perspective of one embodiment of a microwave system for use with the apparatus of FIG. 1;

FIG. 3 is a perspective of a second embodiment of a microwave system for use with the apparatus of FIG. 1;

FIG. 4 is a perspective of a third embodiment of a microwave system for use with the apparatus of FIG. 1;

FIG. 5 is a perspective of a fourth embodiment of a microwave system for use with the apparatus of FIG. 1;

FIG. 6 is a perspective of a fifth embodiment of a microwave system for use with the apparatus of FIG. 1; and

FIG. 7 is a perspective of a sixth embodiment of a microwave system for use with the apparatus of FIG. 1.

Corresponding reference characters indicate corresponding parts throughout the drawings.

### DETAILED DESCRIPTION

The present disclosure provides for methods of using compositions having improved microwave absorbing properties to cut textile webs. More particularly, it has been found that compositions having improved microwave absorbing properties can cut textile webs in a series of two to three steps. First, as the composition has a strong affinity for microwave energy, the composition absorbs a great amount of energy and converts the microwave energy into heat, thereby melting the substrate material directly below the composition. As the heat increases, the substrate material directly below the composition decomposes and the textile web begins to break apart. Finally, the decomposed substrate material is removed from the remainder of the textile web through volatization, producing a cut textile web. In some embodiments, the substrate material does not melt with the increased heat produced by the composition, but instead, is immediately decomposed due to the increased temperature and the decomposed substrate material is then volatized as described above.

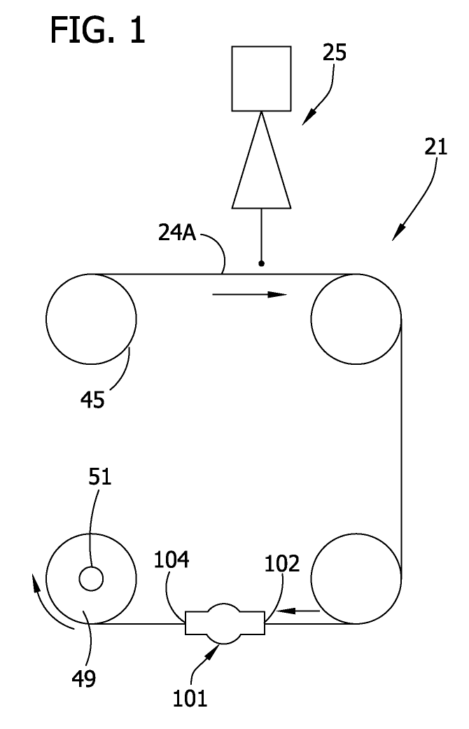

With reference now to the drawings and in particular to FIG. 1, one embodiment of an apparatus for use in cutting textile webs is generally designated 21. In one suitable embodiment, the textile web 23 to be processed by the apparatus 21 is suitably made up of one or more substrates made from materials such as a woven web, but may also be a non-woven web, including without limitation bonded-carded webs, spunbond webs and meltblown webs, polyesters, polyolefins such as polypropylenes and polyethylenes, cottons, nylons, silks, hydroknits, coform materials, nanofibers, fluff batting, foams, elastomerics, rubbers, film laminates, combinations of these materials or other suitable materials. The textile web 23 may be a single substrate or a multilayer laminate in which one or more substrates of the textile web are suitable for being cut.

The term “spunbond” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns.

The term “meltblown” refers to fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

Laminates of spunbond and meltblown fibers may be made, for example, by sequentially depositing onto a moving forming belt first a spunbond substrate, then a meltblown substrate and last another spunbond substrate and then bonding the layers together using any method known by one skilled in the art. Alternatively, the substrates may be made individually, collected in rolls, and combined in a separate bonding step using any method known in the art. Such laminates usually have a basis weight of from about 0.1 to 12 osy (6 to 400 gsm), or more particularly from about 0.75 to about 3 osy.

The cutting apparatus 21 suitably comprises an applicating device, schematically and generally indicated at 25, operable to apply the composition to at least one face 24a, 24b of a textile web 23. For example, in the embodiment illustrated in FIG. 1, the applicating device is particularly operable to apply composition to only one face 24a of the textile web 23. It is understood, however, that the applicating device may be operable to apply composition only to the opposite face 24b of the textile web 23, or to both faces of the textile web 23. It is also contemplated that more than one applicating device may be used (e.g., one corresponding to each face 24a, 24b of the textile 23) to apply composition to both faces of the textile web either concurrently or sequentially.

In one particularly preferred embodiment, the composition is a dye. The term “dye” as used herein refers to a substance that imparts more or less permanent color to other materials, such as to the textile web 23. Suitable dyes include, without limitation, inks, lakes (also often referred to as color lakes), pigments and other colorants. In one embodiment, the dye has a viscosity in the range of about 2 centipoises (cPs) to about 100 cPs, more suitably in the range of about 2 cPs to about 20 cPs, and even more suitably in the range of about 2 cPs to about 10 cPs.

Furthermore, in a particularly suitable embodiment, the composition is a composition that provides an enhanced absorption of microwave energy, such as by having a relatively high dielectric loss factor. For example, the composition may suitably have a dielectric loss factor at 900 MHz and 22 degrees Celsius of at least about 5, more suitably at least about 10, even more suitably at least about 11, and even more suitably at least about 14. For comparison purposes, the dielectric loss factor of water under the same conditions is less than about 3.8. In another suitable embodiment, the composition has a dielectric loss factor at 2,450 MHz and 22 degrees Celsius of at least about 10, more suitably at least about 15, and even more suitably at least about 17. Water has a dielectric loss factor of about 9.6 or lower under these same conditions.

As used herein, the “dielectric loss factor” is a measure of the receptivity of a material to high-frequency energy. The measure value of ε′ is most often referred to as the dielectric constant, while the measured value of ε″ is denoted as the dielectric loss factor. These values can be measured directly using the processing conditions provided by testing method ASTM D2520 and a Network Analyzer with a low power, external electric field (i.e., 0 dBm to +5 dBm) typically over a frequency range of 300 KHz to 3 GHz, although Network Analyzers to 20 GHz are readily available. Most commonly dielectric loss factor is measured at a frequency of either 900 MHz or 2,450 MHz (and at room temperature, such as about 22 degrees Celsius). For example, a suitable measuring system can include an HP8720D Dielectric Probe, and a model HP8714C Network Analyzer, both available from Agilent Technologies of Brookfield, Wis. U.S.A. Additional suitable analyzers can include models HP8592B and 8593E, also available from Agilent Technologies of Brookfield, Wis. U.S.A. Substantially equivalent devices may also be employed. By definition ε″ is always positive, and a value of less than zero is occasionally observed when ε″ is near zero due to the measurement error of the analyzer.

As such, the composition may include additives or other materials to enhance the affinity of the composition to microwave energy. Examples of such additives and materials include, without limitation, various mixed valent oxides, such as magnetite, nickel oxide and the like; carbon, carbon black and graphite; sulfide semiconductors, such as FeS₂ and CuFeS₂; silicon carbide; various metal powders such as powders of aluminum, iron and the like; various hydrated salts and other salts, such as calcium chloride dihydrate; diatomaceous earth; aliphatic polyesters (e.g., polybutylene succinate and poly(butylene succinate-co-adipate), polymers and copolymers of polylactic acid; various hygroscopic or water absorbing materials or more generally polymers or copolymers with many sites of —OH groups.

Examples of other suitable inorganic microwave absorbers include, without limitation, aluminum hydroxide, zinc oxide, barium titanate. Examples of other suitable organic microwave absorbers include, without limitation, polymers containing ester, aldehyde ketone, isocyanate, phenol, nitrile, carboxyl, vinylidene chloride, ethylene oxide, methylene oxide, opoxy, amine groups, polypyrroles, polyanilines, polyalkylthiophenes. Mixtures of the above are also suitable for use in the composition to be applied to the textile web. The selective additive or material may be ionic or dipolar, such that the applied energy field can activate the molecule. Non-limiting examples of suitable compositions that have the desired dielectric loss factor are available from Yuhan-Kimberly, South Korea under the designations: NanoColorant Cyan 220 ml (67581-11005579); NanoColorant Magenta 220 ml (67582-11005580); NanoColorant Yellow 220 ml (67583-11005581); NanoColorant Black 220 ml (67584-11005582); NanoColorant Red 220 ml (67587-11005585); NanoColorant Orange 220 ml (67588-11005586); NanoColorant Gray 220 ml (67591-11005589); and NanoColorant Violet 220 ml (67626-1006045).

The applicating device 25 according to one embodiment may comprise any suitable device used for applying composition to a textile web 23 other than by saturating the entire textile web (e.g., by immersing the textile web in a bath of solution containing the composition to saturate the textile web), whether the composition is pre-metered (e.g., in which little or no excess composition is applied to the textile web upon initial application of the composition) or post-metered (i.e., an excess amount of composition is applied to the textile web and subsequently removed). It is understood that the composition itself may be applied to the textile web 23 or the composition may be used in a solution that is applied to the textile web.

Examples of suitable pre-metered applicating devices 25 include, without limitation, devices for carrying out the following known applicating techniques:

Slot die: The composition is metered through a slot in a printing head directly onto the textile web 23.

Direct gravure: The composition is in small cells in a gravure roll. The textile web 23 comes into direct contact with the gravure roll and the composition in the cells is transferred onto the textile web.

Offset gravure with reverse roll transfer: Similar to the direct gravure technique except the gravure roll transfers the composition to a second roll. This second roll then comes into contact with the textile web 23 to transfer composition onto the textile web.

Curtain coating: This is a coating head with multiple slots in it. Composition is metered through these slots and drops a given distance down onto the textile web 23.

Slide (Cascade) coating: A technique similar to curtain coating except the multiple layers of composition come into direct contact with the textile web 23 upon exiting the coating head. There is no open gap between the coating head and the textile web 23.

Forward and reverse roll coating (also known as transfer roll coating): This consists of a stack of rolls which transfers the composition from one roll to the next for metering purposes. The final roll comes into contact with the textile web 23. The moving direction of the textile web 23 and the rotation of the final roll determine whether the process is a forward process or a reverse process.

Extrusion coating: This technique is similar to the slot die technique except that the composition is a solid at room temperature. The composition is heated to melting temperature in the print head and metered as a liquid through the slot directly onto the textile web 23. Upon cooling, the composition becomes a solid again.

Rotary screen: The composition is pumped into a roll which has a screen surface. A blade inside the roll forces the composition out through the screen for transfer onto the textile web.

Spray nozzle application: The composition is forced through a spray nozzle directly onto the textile web 23. The desired amount (pre-metered) of composition can be applied, or the textile web 23 may be saturated by the spraying nozzle and then the excess composition can be squeezed out (post-metered) by passing the textile web through a nip roller.

Flexographic printing: The composition is transferred onto a raised patterned surface of a roll. This patterned roll then contacts the textile web 23 to transfer the composition onto the textile web.

Digital textile printing: The composition is loaded in an ink jet cartridge and jetted onto the textile web 23 as the textile web passes under the ink jet head.

Examples of suitable post-metering applicating devices for applying the composition to the textile web 23 include without limitation devices that operate according to the following known applicating techniques:

Rod coating: The composition is applied to the surface of the textile web 23 and excess composition is removed by a rod. A Mayer rod is the prevalent device for metering off the excess composition.

Air knife coating: The composition is applied to the surface of the textile web 23 and excess composition is removed by blowing it off using a stream of high pressure air.

Knife coating: The composition is applied to the surface of the textile web 23 and excess composition is removed by a head in the form of a knife.

Blade coating: The composition is applied to the surface of the textile web 23 and excess composition is removed by a head in the form of a flat blade.

Spin coating: The textile web 23 is rotated at high speed and excess composition applied to the rotating textile web spins off the surface of the textile web.

Fountain coating: The composition is applied to the textile web 23 by a flooded fountain head and excess composition is removed by a blade.

Brush application: The composition is applied to the textile web 23 by a brush and excess composition is regulated by the movement of the brush across the surface of the textile web.

As the textile web 23 passes the applicating device 25, composition is applied to the one face 24a of the textile web 23. Typically, from about 5 grams/square meter (g/m²) to about 100 g/m² composition is applied to the textile web. More suitably, from about 10 g/m² to about 40 g/m² composition is applied to the textile web.

As noted above, the composition is applied to the textile web in a specific pattern. Any method of applying the composition in a pattern known to one skilled in the art can be used. Suitable patterns for applying the composition include stripes, circles, ellipses, rectangles, squares, triangles, angled lines, curved lines, and combinations thereof. It is to be noted that the pattern applied using the composition will generally determine the outer boundaries of the cut textile web once microwave energy has been applied to the textile web; that is, the applied pattern of composition heats rapidly when exposed to microwave energy as described above and the textile web immediately below the pattern of composition is cut.

With reference now back to FIG. 1, following the formation of the textile web, the textile web 23 is then advanced to, and through, a microwave system, generally indicated at 101 operable to direct high frequency, electromagnetic radiant energy, and more suitably microwave energy, to the textile web to facilitate expedited and enhanced heating and cutting of the textile web by the composition. In one particularly suitable embodiment, for example, the microwave system 101 may employ energy having a frequency in the range of about 0.01 MHz to about 5,800 MHz, and more suitably from about 900 MHz to about 2,450 MHz.

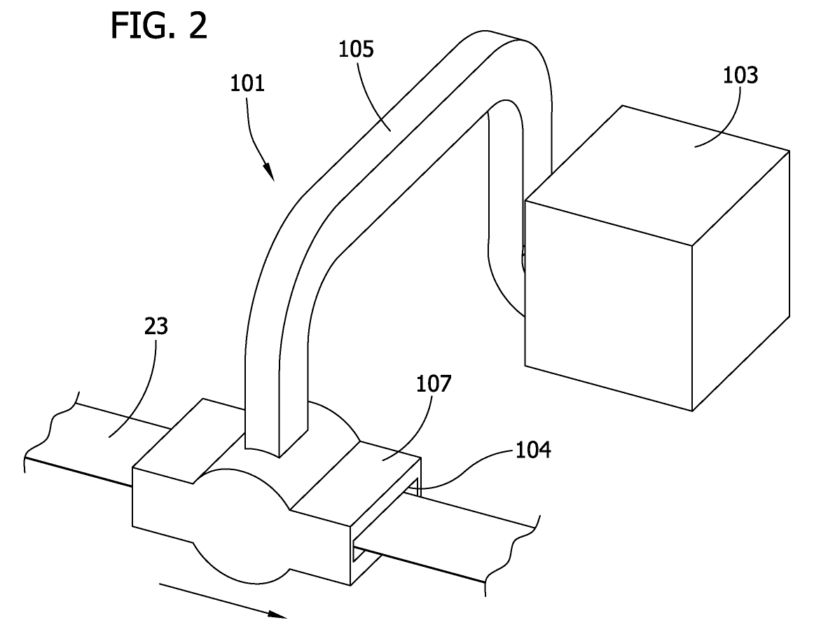

The microwave system 101, with reference to FIG. 2, suitably comprises a microwave generator 103 operable to produce the desired amount of microwave energy, a wave-guide 105 and an application chamber 107 through which the textile web 23 passes while moving in the machine direction (indicated by the direction arrow in FIG. 2). For example, the input power of the microwave generator is suitably in the range of about 0.1 kilowatts to about 1,000 kilowatts. It is understood, however, that in other embodiments the power input may be substantially greater, such as about 10,000 watts or more, without departing from the scope of this invention. It should be understood by one skilled in the art that the operation parameters of: the amount of composition, the input power of the microwave generator, and the dwell time of the textile web within the microwave application chamber (as discussed more fully below) can be manipulated to control the ability and extent of cutting the textile web with the composition. For example, if more composition is added to the textile web, less power is required to melt the composition and decompose the textile web. Furthermore, if the textile web is allowed to remain in the application chamber for a longer period of time, less power and less composition is required for cutting.

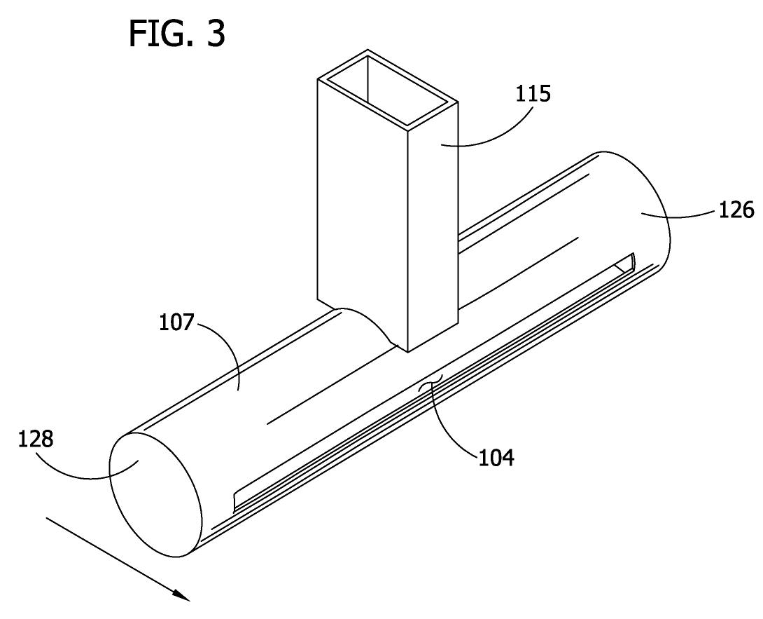

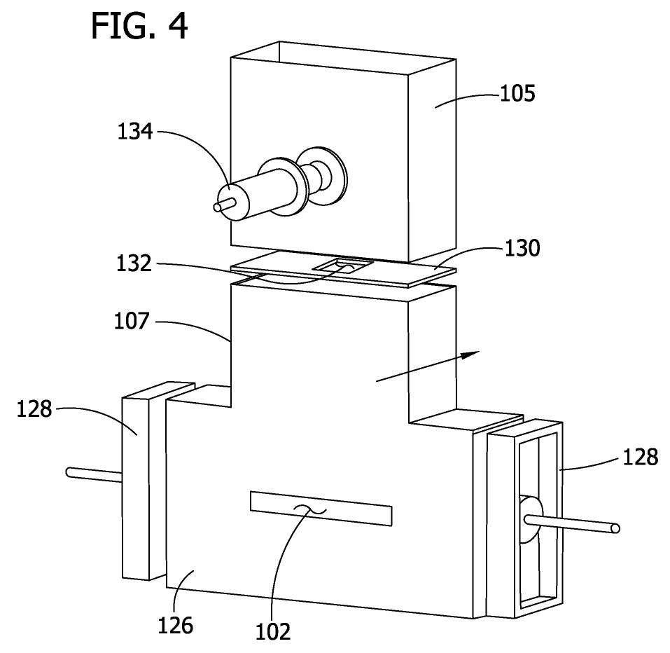

In a particular embodiment, illustrated in FIG. 3, the application chamber 107 comprises a housing 126 operatively connected to the wave-guide 105 and having end walls 128, an entrance opening (not shown in FIG. 3 but similar to an entrance opening 102 shown in FIG. 4) for receiving the textile web 23 into the application chamber, and an outlet opening 104 through which the textile web 23 exits the application chamber for subsequent movement to the wind roll 49. The entrance and exit openings 102, 104 can be suitably sized and configured slightly larger than the textile web 23 so as to allow the textile web, in its open configuration, to pass through the entrance and exit while inhibiting an excessive leakage of energy from the application chamber. The wave-guide 105 and application chamber 107 may be constructed from suitable non-ferrous, electrically-conductive materials, such as aluminum, copper, brass, bronze, gold and silver, as well as combinations thereof.

The application chamber 107 in one particularly suitable embodiment is a tuned chamber within which the microwave energy can produce an operative standing wave. For example, the application chamber 107 may be configured to be a resonant chamber. Examples of suitable arrangements for a resonant application chamber 107 are described in U.S. Pat. No. 5,536,921 entitled SYSTEM FOR APPLYING MICROWAVE ENERGY IN SHEET-LIKE MATERIAL by Hedrick et al., issued Jul. 16, 1996; and in U.S. Pat. No. 5,916,203 entitled COMPOSITE MATERIAL WITH ELASTICIZED PORTIONS AND A METHOD OF MAKING THE SAME by Brandon et al, issued Jun. 29, 1999. The entire disclosures of these documents are incorporated herein by reference in a manner that is consistent herewith.

In another embodiment, the effectiveness of the application chamber 107 can be determined by measuring the power that is reflected back from the impedance load provided by the combination of the application chamber 107 and the target material (e.g. the textile web 23) in the application chamber. In a particular aspect, the application chamber 107 may be configured to provide a reflected power which is not more than a maximum of about 50% of the power that is delivered to the impedance load. The reflected power can alternatively be not more than about 20% of the delivered power, and can optionally be not more than about 10% of the delivered power. In other embodiments, however, the reflected power may be substantially zero. Alternatively, the reflected power may be about 1%, or less, of the delivered power, and can optionally be about 5%, or less, of the delivered power. If the reflected power is too high, inadequate levels of energy are being absorbed by the textile web 23 and the power being directed into the textile web is being inefficiently utilized.

The application chamber 107 may also be configured to provide a Q-factor of at least a minimum of about 200. The Q-factor can alternatively be at least about 5,000, and can optionally be at least about 10,000. In other embodiments, the Q-factor can be up to about 20,000, or more. If the Q-factor is too low, inadequate electrical field strengths are provided to the textile web. The Q-factor can be determined by the following formula (which may be found in the book entitled Industrial Microwave Heating by R. C. Metaxas and R. J. Meredith, published by Peter Peregrinus, Limited, located in London, England, copyright 1983, reprinted 1993):

Q-factor=fₒ/Δf

where: fₒ=intended resonant frequency (typically the frequency produced by the high-frequency generator), and

Δf=frequency separation between the half-power points.

In determining the Q-factor, the power absorbed by the textile web 23 is deemed to be the power delivered into the application chamber 107 to the textile web, minus the reflected power returned from the application chamber. The peak-power is the power absorbed by the textile web 23 when the power is provided at the intended resonant frequency, fₒ. The half-power points are the frequencies at which the power absorbed by the textile web 23 falls to one-half of the peak-power.

For example, a suitable measuring system can include an HP8720D Dielectric Probe, and a model HP8714C Network Analyzer, both available from Agilent Technologies, a business having offices located at Brookfield, Wis. U.S.A. Other suitable analyzers can include models HP8592B and 8593E, also available from Agilent Technologies of Brookfield, Wis. U.S.A. A suitable procedure for determining the Q-factor is described in the User's Manual dated 1998, part number 08712-90056. Substantially equivalent devices and procedures may also be employed.

In another aspect, the application chamber 107 may be configured for selective tuning to operatively “match” the load impedance produced by the presence of the target material (e.g. the textile web 23) in the application chamber. The tuning of the application chamber 107 can, for example, be provided by any of the techniques that are useful for “tuning” microwave devices. Such techniques can include configuring the application chamber 107 to have a selectively variable geometry, changing the size and/or shape of a wave-guide aperture, employing adjustable impedance components (e.g. stub tuners), employing a split-shell movement of the application chamber, employing a variable frequency energy source that can be adjusted to change the frequency of the energy delivered to the application chamber, or employing like techniques, as well as employing combinations thereof. The variable geometry of the application chamber 107 can, for example, be provided by a selected moving of either or both of the end walls 128 to adjust the distance therebetween.

As representatively shown in FIGS. 4-7, the tuning feature may comprise an aperture plate 130 having a selectively sized aperture 132 or other opening. The aperture plate 130 may be positioned at or operatively proximate the location at which the wave-guide 105 joins the application chamber housing 126. The aperture 132 can be suitably configured and sized to adjust the waveform and/or wavelength of the energy being directed into the application chamber 107. Additionally, a stub tuner 134 may be operatively connected to the wave-guide 105. With reference to FIG. 4, the wave-guide 105 can direct the microwave energy into the chamber 107 at a location that is interposed between the two end walls 128. Either or both of the end walls 128 may be movable to provide selectively positionable end-caps, and either or both of the end walls may include a variable impedance device, such as provided by the representatively shown stub tuner 134. Alternatively, one or more stub tuners 134 may be positioned at other operative locations in the application chamber 107.

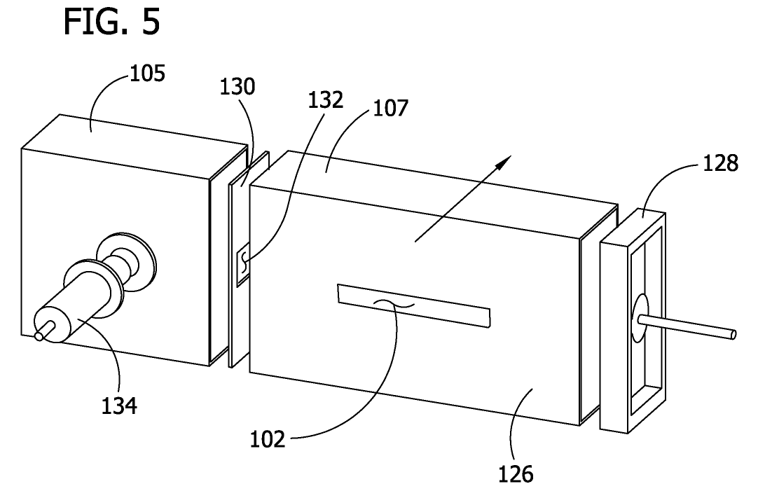

With reference to FIG. 5, the wave-guide 105 may be arranged to deliver the microwave energy into one end of the application chamber 107. Additionally, the end wall 128 at the opposite end of the chamber 107 may be selectively movable to adjust the distance between the aperture plate 130 and the end wall 128.

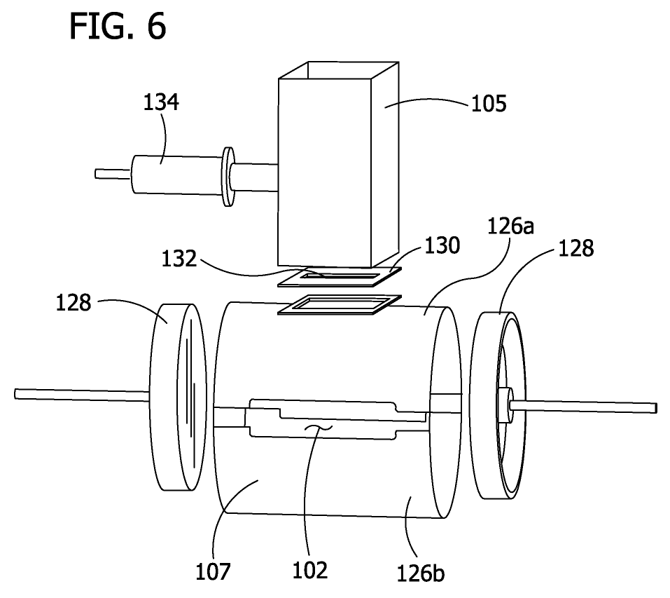

In the embodiment illustrated in FIG. 6, the application chamber 107 comprises a housing 126 that is non-rectilinear. In a further feature, the housing 126 may be divided to provide operatively movable split portions 126a and 126b. The chamber split-portions 126a, 126b can be selectively postionable to adjust the size and shape of the application chamber 107. As representatively shown, either or both of the end walls 128 are movable to provide selectively positionable end-caps, and either or both of the end walls may include a variable impedance device, such as provided by the representatively shown stub tuner 134. Alternatively, one or more stub tuners 134 may be positioned at other operative locations in the chamber 107.

To tune the application chamber 107, the appointed tuning components are adjusted and varied in a conventional, iterative manner to maximize the power into the load (e.g. into the textile web), and to minimize the reflected power. Accordingly, the tuning components can be systematically varied to maximize the power into the textile web 23 and minimize the reflected power. For example, the reflected power can be detected with a conventional power sensor, and can be displayed on a conventional power meter. The reflected power may, for example, be detected at the location of an isolator. The isolator is a conventional, commercially available device which is employed to protect a magnetron from reflected energy. Typically, the isolator is placed between the magnetron and the wave-guide 105. Suitable power sensors and power meters are available from commercial vendors. For example, a suitable power sensor can be provided by a HP E4412 CW power sensor which is available from Agilent Technologies of Brookfield, Wis. U.S.A. A suitable power meter can be provided by a HP E4419B power meter, also available from Agilent Technologies.

In the various configurations of the application chamber 107, a properly sized aperture plate 130 and a properly sized aperture 132 can help reduce the amount of variable tuning adjustments needed to accommodate a continuous product. The variable impedance device (e.g. stub tuner 134) can also help to reduce the amount of variable tuning adjustments needed to accommodate the processing of a continuous textile web 23. The variable-position end walls 128 or end caps can allow for easier adjustments to accommodate a varying load. The split-housing 126a, 126b (e.g., as illustrated in FIG. 6) configuration of the application chamber 107 can help accommodate a textile web 23 having a varying thickness.

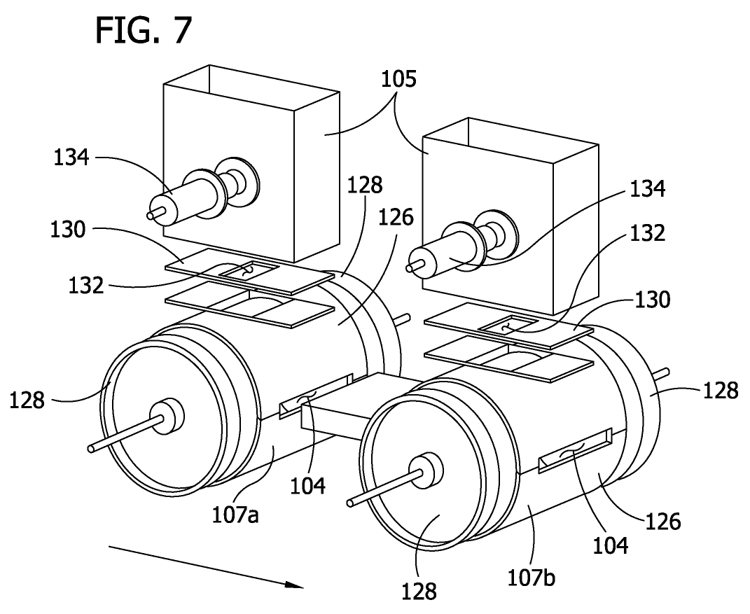

In another embodiment, illustrated in FIG. 7, the microwave system 101 may comprise two or more application chambers 107 (e.g. 107a+107b+ . . . ). The plurality of activation chambers 107 can, for example, be arranged in the representatively shown serial array.

As one example of the size of the application chamber 107, throughout the various embodiments the chamber may suitably have a machine-directional (indicated by the direction arrow in the various embodiments) length (e.g., from the entrance 102 to the exit 104, along which the web is exposed to the microwave energy in the chamber) of at least about 20 cm. In other aspects, the chamber 107 length can be up to a maximum of about 800 cm, or more. The chamber 107 length can alternatively be up to about 400 cm, and can optionally be up to about 200 cm.

Where the microwave system 101 employs two or more application chambers 107 arranged in series, the total sum of the machine-directional lengths provided by the plurality of chambers may be at least about 40 cm. In other aspects, the total of the chamber 107 lengths can be up to a maximum of about 3000 cm, or more. The total of the chamber 107 lengths can alternatively be up to about 2000 cm, and can optionally be up to about 1000 cm.

The total residence time within the application chamber 107 or chambers can provide a distinctively efficient dwell time. The term “dwell time” in reference to the microwave system 101 refers to the amount of time that a particular portion of the textile web 23 spends within the application chamber 107, e.g., in moving from the entrance opening 102 to the exit opening 104 of the chamber. In a particular aspect, the dwell time is suitably at least about 0.0002 sec. The dwell time can alternatively be at least about 0.005 sec, and can optionally be at least about 0.01 sec. In other embodiments the dwell time can be up to a maximum of about 3 sec, more suitably up to about 2 sec, and optionally up to about 1.5 sec. In one particularly preferred embodiment, the application chamber can provide a dwell time of the textile web within the chamber of a range of from about 0.01 seconds to about 3 seconds.

In operation, after the textile web 23 is formed, the textile web is moved (e.g., drawn, in the illustrated embodiment) through the application chamber 107 of the microwave system 101. The microwave system 101 is operated to direct microwave energy into the application chamber 107 for melting of the composition (e.g., which in one embodiment suitably has an affinity for, or couples with, the microwave energy). The composition is thus heated rapidly, thereby substantially speeding up the rate at which at the composition melts into the textile web, thereby cutting the textile web (e.g., as opposed to conventional heating methods such as ultrasonic bonding). The textile web is subsequently moved downstream of the microwave system 101 for subsequent post-processing, such as washing to remove any unbound composition, and other suitable post-processing steps.

The present disclosure is illustrated by the following examples which are merely for the purpose of illustration and are not to be regarded as limiting the scope of the disclosure or manner in which it may be practiced.

### EXAMPLE 1

In this Example, a dye composition was applied to a textile web and the web was then subjected to microwave energy to determine the ability of the dye composition to absorb the microwave energy and cut the textile web.

For this Example, a master roll of polyester, commercially available as Polyester Georgette, style no. 700-13 from Test Fabrics (West Pittston, Pa.) was used as the textile web. The web has a basis weight of about 58 grams per square meter and is approximately four inches (about 10.2 cm) wide.

A black dye, commercially available from Yuhan-Kimberly of South Korea under the designation 67584-11005582 NanoColorant Black 220 ml, was used as the dye solution. The applicating device was an electrometric air atomizing spray nozzle, Model No. 79200 available from Spraymation (Fort Lauderdale, Fla.). The applicating device was operated at a rate of about 35 grams/square meter.

The microwave system used was similar to that described above and illustrated in FIG. 5 and capable of delivering up to 6 KW of power. The resonant cavity of the microwave system had a depth (i.e., in the machine direction of movement of the web through the cavity) of about 5 inches (12.7 cm).

The master web, in rolled form, was placed on an unwind roll and unrolled and drawn through the microwave system in an open configuration by a suitable wind roll and drive mechanism at a feed rate of about 4 ft./min. (about 1.2 meters/min.). Before the web reached the microwave system, the dye composition was sprayed by the applicating device onto the face of the web that faces away from the microwave system (referred to further herein as the front face of the web). The web was drawn through the resonant cavity of the microwave system, which operated at a frequency of approximately 2,450 MHz and absorbed power of approximately 500 watts, and then to the wind roll.

It was found that the web material immediately below the dye composition was cut and the rest of the textile web was left unaltered.

### EXAMPLE 2

In this Example, various adhesive compositions were analyzed to determine their respective dielectric loss factors. The dielectric loss factors of the various adhesive compositions were then compared to the dielectric loss factors of two water control samples analyzed under the same conditions.

Specifically, the dielectric constant (ε′) and loss tangent (D) for each of the adhesive compositions (all commercially available from Yuhan-Kimberly, South Korea) listed in Table 1 were measured using the equipment, conditions and procedures as required by ASTM D2520, Test Method C. The dielectric constant (ε′) and loss tangent (D) for each of the adhesive compositions were tested at both 900 MHz and 2,450 MHz. Each adhesive composition was tested six times and the values of the dielectric constant (ε′) and loss tangent (D) were then averaged. Furthermore, two control samples were also tested; the first control sample, Control A, was deionized water, and the second control sample, Control B, was Ultrapure water. The averaged values of the dielectric constant (ε′) and loss tangent (D) for each sample are shown in Table 1:

TABLE 1

| | Dielectric | | | |
|---|---|---|---|---|
| | Constant (ε′) | | Loss Tangent (D) | |
| Sample | 900 MHz | 2,450 MHz | 900 MHz | 2,450 MHz |
| NanoColorant | 63.2 | 62.1 | 0.179 | 0.299 |
| Black N-101 | | | | |
| NanoColorant | 64.9 | 64.3 | 0.267 | 0.311 |
| Cyan N-102 | | | | |
| NanoColorant | 66.9 | 66.3 | 0.214 | 0.265 |
| Magenta N-103 | | | | |
| NanoColorant | 64.1 | 63.4 | 0.287 | 0.319 |
| Yellow N-104 | | | | |
| NanoColorant | 64.2 | 63.5 | 0.261 | 0.291 |
| Orange N-105 | | | | |
| NanoColorant | 65.2 | 64.7 | 0.273 | 0.314 |
| Red N-106 | | | | |
| NanoColorant | 65.4 | 64.9 | 0.248 | 0.278 |
| Violet N-107 | | | | |
| NanoColorant | 63.4 | 62.7 | 0.281 | 0.366 |
| Grey N-108 | | | | |
| Control A | 78.2 | 77.8 | 0.048 | 0.123 |
| Control B | 78.3 | 77.9 | 0.045 | 0.121 |

To calculate the dielectric loss factor (ε″), the following formula was used:

Dielectric Loss Factor (ε″)=(Dielectric Constant (ε′)×Loss Tangent (D))

The dielectric loss factors for the adhesive compositions and the control samples are shown in Table 2:

TABLE 2

Loss Factor

| Sample | 900 MHz | 2,450 MHz |
|---|---|---|
| NanoColorant Black N-101 | 11.31 | 18.57 |
| NanoColorant Cyan N-102 | 17.33 | 20.00 |
| NanoColorant Magenta N-103 | 14.32 | 17.57 |
| NanoColorant Yellow N-104 | 18.40 | 20.22 |
| NanoColorant Orange N-105 | 16.76 | 18.48 |
| NanoColorant Red N-106 | 17.80 | 20.32 |
| NanoColorant Violet N-107 | 16.22 | 18.04 |
| NanoColorant Grey N-108 | 17.82 | 22.95 |
| Control A | 3.75 | 9.57 |
| Control B | 3.52 | 9.43 |

When introducing elements of the present invention or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A process for cutting a textile web, the process comprising:
applying a composition having a dielectric loss factor at 900 MHz and 22 degrees Celsius of at least about 5 in a pattern to the first face of the textile web;
moving the textile web through a microwave application chamber of a microwave system; and
operating the microwave system to impart microwave energy to the textile web in the microwave application chamber to facilitate cutting of the textile web.

2. The process as set forth in claim 1 wherein the pattern on the first face of the textile web is selected from the group consisting of stripes, circles, ellipses, rectangles, squares, triangles, angled lines, curved lines, and combinations thereof.

3. The process as set forth in claim 1 wherein the composition has a dielectric loss factor at 900 MHz and 22 degrees Celsius of at least about 10.

4. The process as set forth in claim 1 wherein the composition has a dielectric loss factor at 900 MHz and 22 degrees Celsius of at least about 14.

5. The process set forth in claim 1 wherein the composition has a dielectric loss factor at 2,450 MHz and 22 degrees Celsius of at least about 10.

6. The process set forth in claim 1 wherein the composition has a dielectric loss factor at 2,450 MHz and 22 degrees Celsius of at least about 15.

7. The process as set forth in claim 1 wherein the step of applying composition to the first face of the textile web comprises applying composition other than by saturating the textile web.

8. The process as set forth in claim 1 wherein from about 5 g/m² to about 100 g/m² composition is applied to the first face of the textile web.

9. The process as set forth in claim 1 wherein from about 10 g/m² to about 40 g/m² composition is applied to the first face of the textile web.

10. The process as set forth in claim 1 wherein the step of operating the microwave system comprises operating the microwave system at a frequency in the range of from about 0.01 MHz to about 5,800 MHz.

11. The process as set forth in claim 1 wherein the step of operating the microwave system comprises operating the microwave system at a frequency in the range of from about 900 MHz to about 2,450 MHz.

12. The process as set forth in claim 1 wherein the step of operating the microwave system comprises operating the microwave system at a power input in the range of from about 0.1 Kilowatt to about 1,000 Kilowatts.

13. The process as set forth in claim 1 wherein the microwave application chamber has a length along which microwave energy is imparted to the textile web as the textile web passes along the length of the chamber, the step of moving the web through the microwave application chamber comprising moving the textile web through the chamber at a rate relative to the microwave application chamber length to define a dwell time of the textile web within the chamber in the range of at least about 0.0002 seconds.

14. The process as set forth in claim 1 wherein the microwave application chamber has a length along which microwave energy is imparted to the textile web as the textile web passes along the length of the chamber, the step of moving the web through the microwave application chamber comprising moving the textile web through the chamber at a rate relative to the microwave application chamber length to define a dwell time of the textile web within the chamber in the range of from about 0.01 seconds to about 3 seconds.

15. The process as set forth in claim 1 wherein the textile web is made from a material selected from the group consisting of non-woven webs, bonded-carded webs, spunbond webs, meltblown webs, polyesters, polyolefins, cotton, nylon, silks, hydroknits, coform materials, nanofibers, fluff batting, foam, elastomerics, rubber, film laminates, and combinations thereof.
